(19) United States
(12) Patent Application Publication
(10) Pub. No.: US 2018/0333830 A1
(43) Pub. Date: Nov. 22, 2018

(54) Looped Handle Valve Wrench

(71) Applicants: Nathan Todd Cundiff, Alvin, TX (US); Christopher Chance Cundiff, Pearland, TX (US)

(72) Inventors: Nathan Todd Cundiff, Alvin, TX (US); Christopher Chance Cundiff, Pearland, TX (US)

(73) Assignees: Nathan Todd Cundiff, Alvin, TX (US); Christopher Chance Cundiff, Pearland, TX (US)

(21) Appl. No.: 15/597,180

(22) Filed: May 17, 2017

(51) Int. Cl. B25B 13/50; B25G 1/10

(52) U.S. Cl. CPC B25B 13/5008; B25G 1/102

(57) ABSTRACT

This embodiment provides protection to a person turning a valve hand-wheel while using a valve-wrench from being struck or pinched by a valve-wrench. The present embodiment has a looped handle (FIG. 2, 5B) connected on one end of a conjoining rod (FIG. 2, 8A) that terminates on the opposite end into a fixed wheel-rim engaging jaw (FIG. 2, 7A). By allowing the hand of the user to grip one side of the looped-handle that is not in danger (FIG. 2, 3B) of striking another object during rotational travel (FIG. 2, 6A), the leading parts of the user's hand remain protected from impact within the void (FIG. 2, 4B) of the looped-handle (FIG. 2, 5B) by the opposite side (FIG. 2, 5A) of the looped-handle.

### CROSS-REFERENCE TO RELATED APPLICATION

This application claims the benefit of PPA Ser. No. 62/337,356 filed 2016 May 17 by Nathan Cundiff, which is incorporated by reference.

A portion of the disclosure of this patent document contains material which is subject to copyright protection. The copyright owner has no objection to the facsimile reproduction by anyone of the patent document or patent disclosure, as it appears in the Patent and Trademark Office patent file or records, but otherwise reserves all copyright rights whatsoever.

### BACKGROUND

This application relates to a wrench-type tool and more particularly, to a wrench type tool adapted for turning valve wheels.

### PRIOR ART

The following is a tabulation of some prior art that presently appears relevant:

U.S. Patents

| Pat. No. | Kind Code | Issue Date | Patentee |
|---|---|---|---|
| U.S. Pat. No. 4,715,252 | A | Dec. 29, 1987 | Amy Pella |
| U.S. Pat. No. 4,991,469 | A | Feb. 12, 1991 | Paul D. Pella |
| U.S. Pat. No. 2,539,262 | A | Jan. 23, 1951 | Hugh Arthur |
| U.S. Pat. No. 2,682,189 | A | Jun. 29, 1950 | Kirby Wayne |
| U.S. Pat. No. 2,086,722 | A | Jul. 13, 1937 | Charles Matuella |

This application relates to a wrench-type tool and more particularly, to a wrench type tool adapted for turning valve wheels. Valve wheels for which use of this tool is particularly intended are the widely employed types of wheels generally comprising a substantially circular outer rim connected by means such as spokes, to a hub which when the wheel is rotated, functions either to open or close a valve. As is known to those skilled in the art, substantial force must often times be employed to tightly close valves to prevent leakages there-through and similarly, to open tightly closed valves.

Needless to say, it is not broadly new to provide a detachable rod or lever susceptible of releasable engagement with a hand-wheel such as is used in turning some types of valves. Notwithstanding the recognized state of development of the prior art, I feel that I have discovered the need for a better, safer type of auxiliary lever or handle more aptly fitted for the purposes intended and susceptible of more expeditious and disciplined application and removal due to the improvements and refinements in structural features embodied therein. While many of the prior art forms provide claw means for detachable connection with a valve wheel, none of the prior art is designed so the hands of the user are not pinched, fractured, or broken when the handle of the valve-wrench strikes a nearby object.

### SUMMARY

The purpose of the present embodiment of this looped-handle valve-wrench is to provide a safer way of using a valve-wrench to turn a valve hand-wheel. Valve hand-wheels can be difficult to turn and then, suddenly turn freely while much force is being applied to a valve-wrench. When this occurs parts of the hand can rapidly be pinched or struck between the valve-wrench handle and a nearby stationary object. Other accidents involving stubborn valves quickly spinning freely occur when the handle of a valve-wrench is being pulled toward the user and then adequate grip is suddenly lost over the wrench allowing the wrench to strike the user. This present embodiment provides protection to the worker's hand by incorporating a loop at one end of a valve-wrench so the worker can grip and apply force onto the side of the looped-handle that is not in danger of striking another near-by object. This embodiment allows the user better control over the valve-wrench during sudden unexpected hand-wheel spinning and provides protection from being pinched by the wrench and another object in the event the hard to turn hand-wheel suddenly spins freely.

### DRAWINGS—FIGURES

FIG. 1 is a perspective view of one embodiment of the looped-handle valve-wrench that has a curved end.

FIG. 2 is a perspective view of one embodiment of a looped-handle valve-wrench that has a triangular shaped looped-handle, shown in use.

FIG. 3 is a perspective view of one embodiment of a looped-handle valve-wrench that has a triangular shaped looped-handle with an end suitable for releasable engagement with a wheel-rim engaging jaw from another wrench.

### DRAWINGS—REFERENCE NUMERALS

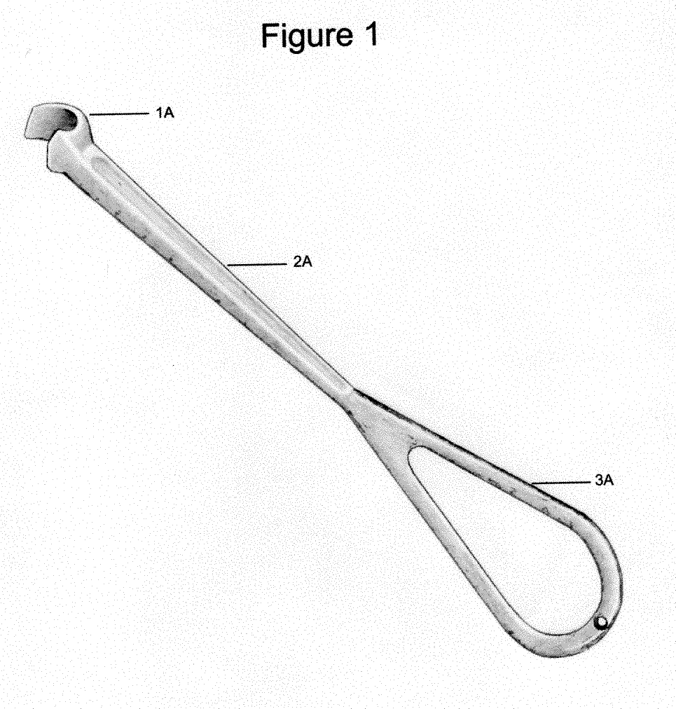

FIG. 1, 1A is a wheel rim engaging jaw

FIG. 1, 2A is a conjoining rod.

FIG. 1, 3A is a looped-handle.

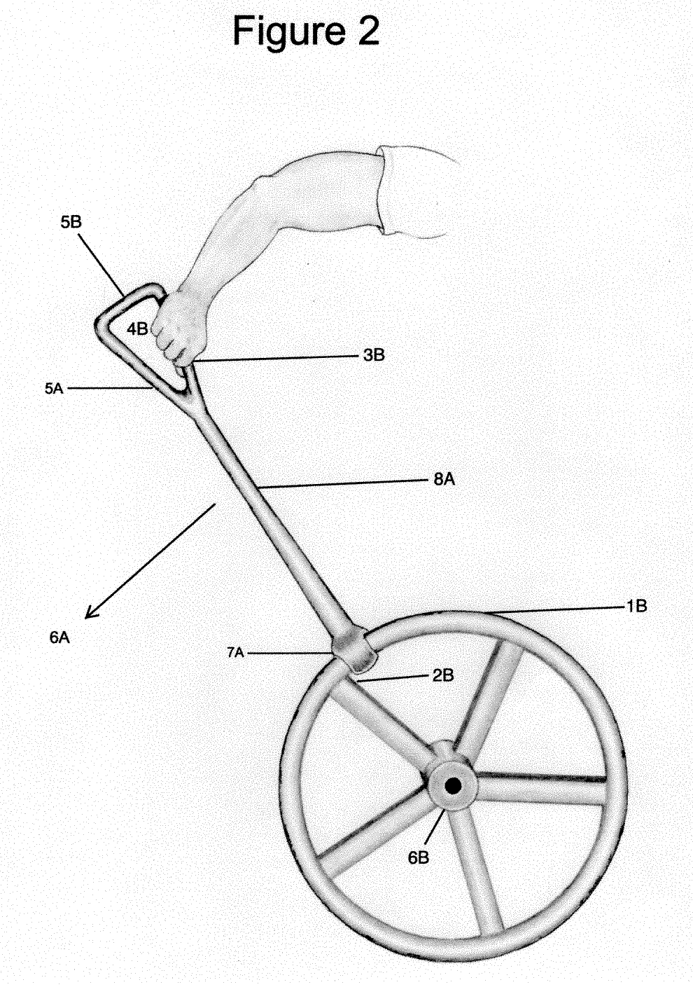

FIG. 2, 5A shows a guarded hand in a protected grip.

FIG. 2, 6A shows the direction of the turning force.

FIG. 2, 7A shows a wheel rim engaging jaw gripping the valve hand-wheel.

FIG. 2, 8A is a conjoining rod.

FIG. 2, 1B is a valve hand-wheel rim.

FIG. 2, 2B is a valve hand-wheel spoke.

FIG. 2, 3B is the side of the looped-handle that is not in danger of striking a nearby object.

FIG. 2, 4B is the void area within the looped-handle.

FIG. 2, 5B is the outermost end of a looped-handle.

FIG. 2, 6B is the hub of a valve hand-wheel.

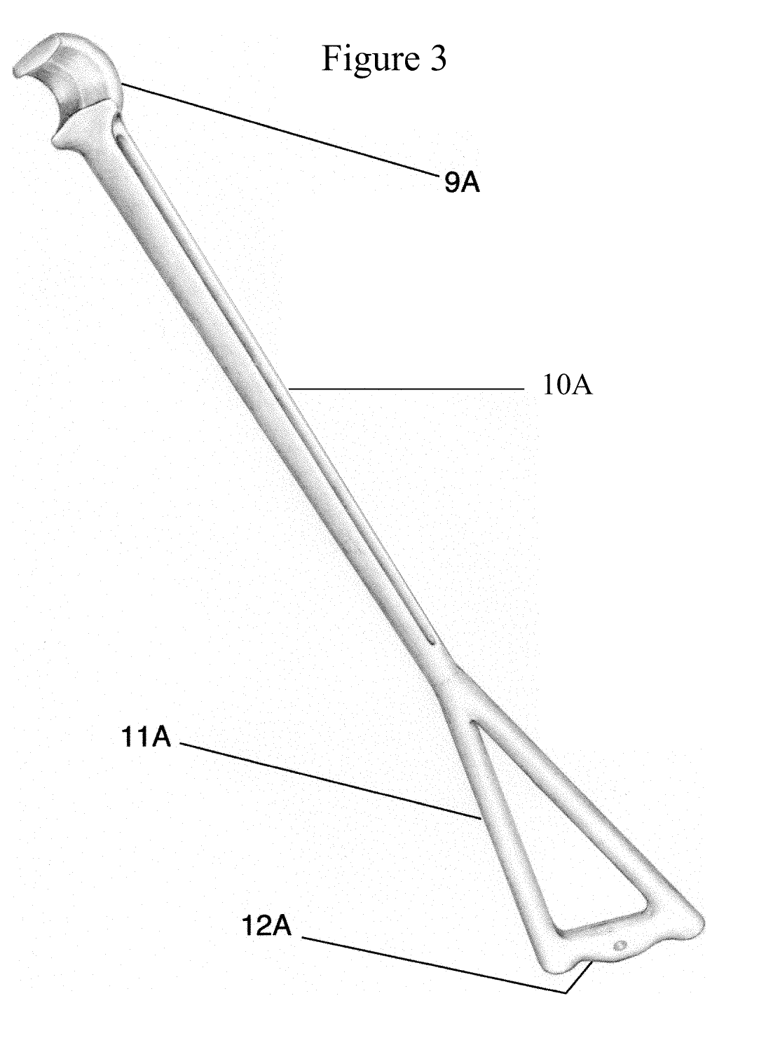

FIG. 3, 9A is a wheel rim engaging jaw.

FIG. 3, 10A is a conjoining rod.

FIG. 3, 11A is a looped-handle.

FIG. 3, 12A is an end of a looped-handle suitable for releasable engagement by a wheel-rim engaging jaw.

### DETAILED DESCRIPTION—FIG. 2—FIRST EMBODIMENT

The embodiment illustrated in FIG. 2, which is shown in use, will be used to describe the looped-handle valve-wrench in the following paragraphs of this section.

The embodiment illustrated in FIG. 2 is a looped-handle valve-wrench where a looped-handle (FIG. 2, 5A) has a triangular shape. The present embodiment in FIG. 2 is one piece and has a conjoining rod (FIG. 2, 8A) terminating on one end into a looped-handle (FIG. 2, 5A) and another end terminating into a fixed wheel-rim engaging jaw (FIG. 2, 7A). Applied force (FIG. 2, 6A) against the looped handle (FIG. 2, 3B) forces fixed wheel-rim engaging jaws (FIG. 2, 7A) against the inner and outer surfaces of a hand-wheel rim (FIG. 2, 1B) and against the inner spoke (FIG. 2, 2B) of a hand-wheel. This leveraged force creates a gripping of the hand-wheel rim (FIG. 2, 1B) while turning the hand-wheel. On the user end (FIG. 2, 5B) of the looped-handle valve-wrench there is a loop (FIG. 2, 5A) not limited to any specific shape with sufficient area in the void (FIG. 2, 4B) so that the palm can grip one side (FIG. 2, 3B). The opposing side of said loop (FIG. 2, 5A) will provide protection to the hand and fingers against any object the wrench handle may strike during travel (FIG. 2, 6A). When pulling the looped-handle valve-wrench toward one's self is required, gripping inside of the valve-wrench looped-handle (FIG. 2, 3B) also gives greater control to the user to stop the valve-wrench from striking the user in the event the tool or the valve-wheel suddenly breaks free.

The present embodiment is constructed from a forged steel alloy which provides adequate strength and ductility for safe and reliable function. Other embodiments could be manufactured with different materials suitable for the service for which is required, e.g. either for chemical compatibility, for non-sparking properties, or to be light-weight. Other forms of manufacture are also widely acceptable for other embodiments of the looped-handle valve-wrench such as but not limited to casting, machining, plasma cutting, water jet cutting, or three dimensional printing.

### DETAILED DESCRIPTION—ALTERNATIVE EMBODIMENTS

The embodiment illustrated in FIG. 1 is a looped-handle valve-wrench where a looped-handle (FIG. 1, 3A) has a curved end. The present embodiment in FIG. 1 is one piece and has a conjoining rod (FIG. 1, 2A) terminating on one end into a looped-handle (FIG. 1, 3A) and another end terminating into a fixed wheel-rim engaging jaw (FIG. 1, 1A).

The embodiment illustrated in FIG. 2 is a looped-handle valve-wrench where a looped-handle (FIG. 2, 5A) has a triangular shape. The present embodiment in FIG. 2 is one piece and has a conjoining rod (FIG. 2, 8A) terminating on one end into a looped-handle (FIG. 2, 5A) and another end terminating into a fixed wheel-rim engaging jaw (FIG. 2, 7A).

The embodiment illustrated in FIG. 3 is a looped-handle valve-wrench in which a triangular-shaped looped-handle (FIG. 3, 11A) has an end (FIG. 3, 12A) suitable for releasable engagement with a wheel-rim engaging jaw (FIG. 3, 9A) from another similar type valve-wrench.

The embodiments illustrated in FIG. 1, FIG. 2, and FIG. 3 provide advantages to one or more aspects to the use of the looped-handle valve-wrench in various applications. Other embodiments of the looped-handle valve-wrench are similar to the embodiments shown in FIG. 1, FIG. 2, and FIG. 3, and are likewise different in shape and appearance; these other embodiments also provide advantages for one or more aspects of the use of the looped-handle valve-wrench for various applications.

### CONCLUSION, RAMIFICATION, AND SCOPE

Accordingly, the reader will see that the mechanically advantaged arrangements of various embodiments of the looped-handle valve-wrench do in fact allow a user to safely apply substantial force against a valve-wheel with less possibility of smashing one's hands or fingers between the valve-wrench and a nearby object. Although the description above contains some specificities, these should not be construed as limiting the scope of the embodiments but merely providing illustrations of one or more of the embodiments. For example, another embodiment of the looped-handle valve-wrench designed to turn smaller valves could have the looped-handle attached directly to the wheel-rim engaging jaw so that the looped handle acts as both the handle, and the conjoining rod.

Another example of other possible embodiments could utilize different shaped conjoining sections or varying types of claw fixtures. Thus the scope of the embodiments should be determined by the appended claims and their legal equivalents, rather than the examples given.

2. A valve wheel turning device, comprising:
a. A looped-handle having sufficient clearance within a void of said looped-handle for a user's hand to wrap around a side of said looped-handle.
b. Said looped-handle is part of one end of a hand-wheel turning lever, the same being provided on the opposite end with means for detachable connection with a hand-wheel,
c. said means being such as to permit said hand-wheel to be turned in either direction; whereby said looped-handle provides protection to said user from pinch type and strike type injuries sometimes resulting from turning of said valve-wheel with said valve-wheel turning device.
